(19) United States
(12) Patent Application Publication
(10) Pub. No.: US 2010/0220966 A1
(43) Pub. Date: Sep. 2, 2010

(54) Reliability Multimode Optical Fiber

(76) Inventor: Kevin Wallace Bennett, Hammondsport, NY (US)

Correspondence Address: CORNING INCORPORATED, SP-TI-3-1, CORNING, NY, 14831, US

(21) Appl. No.: 12/686,787

(22) Filed: Jan. 13, 2010

Related U.S. Application Data
(63) Continuation of application No. 61/156,148, filed on Feb. 27, 2009.

(51) Int. Cl. G02B 6/028; G02B 6/10

(52) U.S. Cl. 385/124; 385/147

(57) ABSTRACT

Bend resistant multimode optical fibers are disclosed herein. Multimode optical fibers disclosed herein comprise a core region having a radius greater than 25 microns and a polymer coating applied to the outside of the fiber, the coating spaced from the core no more than 15 microns. The fiber exhibits an overfilled bandwidth at 850 nm greater than 400 MHz-km.

### CROSS-REFERENCE TO RELATED APPLICATIONS

This application claims the benefit of, and priority to U.S. Provisional Patent Application No. 61/156,148 filed on Feb. 27, 2009 entitled, “Improved Reliability Multimode Optical Fiber”, the content of which is relied upon and incorporated herein by reference in its entirety.

### FIELD

The present invention relates generally to optical fibers, and more specifically to multimode optical fibers.

### TECHNICAL BACKGROUND

Optical fibers form the backbone over which much of telecommunications data is transmitted throughout the world. Optical fibers typically include a glass core and glass cladding region, the outer diameter of such glass portions of the fiber being about 125 microns. Optical fibers commonly employ one or more protective polymeric coatings over the glass portion of the fiber.

### SUMMARY

Bend resistant multimode optical fibers are disclosed herein. In some preferred embodiments, the multimode optical fiber comprises a graded index glass core comprising a core radius greater than 25 microns and a polymer coating applied to the outside of the fiber. The coating is preferably spaced from the core no more than 30 microns, more preferably no more than 25 microns from said core, even more preferably less than 20 microns from said core, and even more preferably less than 15 microns from said core. The coating preferably comprises a refractive index between about 1.435 to 1.460 over a temperature range of about 0-50° C. In some preferred embodiments, the fiber exhibits a core radius greater than or equal to 30 microns, more preferably greater than or equal to 35 microns, and even more preferably greater than or equal to 40 microns. The fiber preferably exhibits a core diameter less than 140 microns, more preferably less than 120 microns and in some preferred embodiments even less than 100 microns. The core of the fiber preferably exhibits a peak delta between about 0.8 and 3 percent, more preferably between about 1.5 and 2.5 percent.

In some embodiments, the coating may be comprised of a polymeric material that exhibits a refractive index suitable for guiding light within the multimode core of the optical fiber, e.g. a refractive index between about 1.435 to 1.460 over the temperature range of about 0-50° C. Suitable exemplary coating materials may include fluorinated polymers, such as EFIRON® Polymer Clad Series PC-452 or PC-444 materials commercially available from SSCP CO., LTD 403-2, Moknae, Ansan, Kyunggi, Korea. The coating may in some embodiments be located directly adjacent to and in contact with the multimode core. However, alternatively, a glass cladding region may be located between the multimode core and the polymeric coating. In some embodiments, the glass cladding region may be essentially free of index increasing or index decreasing dopants such as Ge, F, B, or P, e.g. undoped silica glass. Alternatively, the glass cladding region may in some embodiments include a depressed index annular region. The depressed-index annular portion may, for example, comprise glass comprising a plurality of voids, or glass doped with a downdopant such as fluorine, boron or mixtures thereof, or glass doped with one or more of such downdopants and additionally glass comprising a plurality of voids. In some preferred embodiments, a depressed-index annular portion is employed which is comprised of fluorine doped silica glass. In some embodiments, the depressed-index annular portion has a refractive index delta less than about −0.2% and a width of at least 10 microns, more preferably less than about −0.4% and a width of at least 5 microns.

In some embodiments that comprise a cladding region having voids therein, the voids in some preferred embodiments are non-periodically located within the depressed-index annular portion. By “non-periodically located”, we mean that when one takes a cross section (such as a cross section perpendicular to the longitudinal axis) of the optical fiber, the non-periodically disposed voids are randomly or non-periodically distributed across a portion of the fiber (e.g. within the depressed-index annular region). Similar cross sections taken at different points along the length of the fiber will reveal different randomly distributed cross-sectional hole patterns, i.e., various cross sections will have different hole patterns, wherein the distributions of voids and sizes of voids do not exactly match. That is, the voids are non-periodic, i.e., they are not periodically disposed within the fiber structure. These voids are stretched (elongated) along the length (i.e. parallel to the longitudinal axis) of the optical fiber, but do not extend the entire length of the entire fiber for typical lengths of transmission fiber. It is believed that the voids extend along the length of the fiber a distance less than 20 meters, more preferably less than 10 meters, even more preferably less than 5 meters, and in some embodiments less than 1 meter.

Multimode optical fibers are disclosed herein which exhibit very low bend induced attenuation, in particular very low macrobending induced attenuation. High bandwidth may be facilitated by providing low maximum relative refractive index in the core, and low bend losses may be provided, for example, a 1 turn 5 mm diameter mandrel wrap attenuation increase, of less than or equal to 0.5 dB/turn at 850 nm. At the same time, fibers disclosed herein are capable of a numerical aperture greater than 0.20, more preferably greater than 0.22, and most preferably greater than 0.24 and an overfilled bandwidth greater than 500 MHz-km at 850 nm, more preferably greater than 700 MHz-km at 850 nm, more preferably greater than 1000 MHz-km at 850 nm, more preferably greater than 1500 MHz-km at 850 nm.

Using designs disclosed herein, 60 micron or greater diameter core multimode fibers can been made which provide (a) an overfilled (OFL) bandwidth of greater than 500 MHz-km at 850 nm, more preferably greater than 700 MHz-km at 850 nm, more preferably greater than 1000 MHz-km at a wavelength of 850 nm, more preferably greater than 1500 MHz-km at 850 nm. These high bandwidths can be achieved while still maintaining a 1 turn 5 mm diameter mandrel wrap attenuation increase at a wavelength of 850 nm, of less than 0.5 dB, more preferably less than 0.3 dB, even more preferably less than 0.2 dB, and most preferably less than 0.1 dB. These high bandwidths can also be achieved while also maintaining a 1 turn 3 mm diameter mandrel wrap attenuation increase at a wavelength of 850 nm, of less than 0.5 dB, more preferably less than 0.4 dB, and most preferably less than 0.2 dB.

Preferably, the multimode optical fibers disclosed herein exhibit a spectral attenuation of less than 3.5 dB/km at 850 nm, preferably less than 3.0 dB/km at 850 nm, even more preferably less than 2.7 dB/km at 850 nm and still more preferably less than 2.5 dB/km at 850 nm. Preferably, the multimode optical fiber disclosed herein exhibits a spectral attenuation of less than 1.5 dB/km at 1300 nm, preferably less than 1.2 dB/km at 1300 nm, even more preferably less than 0.8 dB/km at 1300 nm. In some embodiments it may be desirable to spin the multimode fiber, as doing so may in some circumstances further improve the bandwidth for optical fiber having a depressed cladding region. By spinning, we mean applying or imparting a spin to the fiber wherein the spin is imparted while the fiber is being drawn from an optical fiber preform, i.e. while the fiber is still at least somewhat heated and is capable of undergoing non-elastic rotational displacement and is capable of substantially retaining the rotational displacement after the fiber has fully cooled.

In some embodiments, the numerical aperture (NA) of the optical fiber is preferably less than 0.36 and greater than 0.22, more preferably greater than 0.24, even more preferably less than 0.32 and greater than 0.24, and most preferably less than 0.30 and greater than 0.24.

The core extends radially outwardly from the centerline to a radius R1, and in some embodiments R1≧30 microns, more preferably R1≧35 microns, and most preferably R1≧40 microns.

In some embodiments, the core has a maximum relative refractive index which is less than or equal to 2.5% and greater than 0.5%, more preferably less than 2.2% and greater than 0.9%, most preferably less than 1.8% and greater than 1.2%.

The fibers disclosed herein are preferably multimoded at the conventional operating wavelengths for such telecommunications fibers, i.e., at least over the wavelength range extending from 850 nm to 1300 nm.

Reduction of the diameter of the glass portion of the optical fiber reduces bend induced stress that might occur in such applications, allowing deployment at smaller bend radii compared to conventional fibers, while still maintaining an acceptable level of induced stress. This, together with the relatively high bandwidth and good bend loss at small bend diameter, make such fibers useful in applications where copper has often been employed, especially very short distance applications requiring very low bend loss at small (e.g. 5 mm or less) bend diameters. Examples of such applications include as cables for connecting one or more internal components of a computer or other electronic device, or for external connections with a computer or other electronic device, e.g. as USB or other cables used to connect computers to various devices.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description present embodiments, and are intended to provide an overview or framework for understanding the nature and character of the invention as it is claimed. The accompanying drawings are included to provide a further understanding of the exemplary embodiments, and are incorporated into and constitute a part of this specification. The drawings illustrate various exemplary embodiments, and together with the description serve to explain the principles and operations of the invention.

### BRIEF DESCRIPTION OF THE DRAWINGS

FIG. 1 shows a schematic representation (not to scale) of the refractive index profile of an exemplary embodiment of multimode optical fiber disclosed herein wherein a polymeric coating is directly adjacent to and in contact with the core.

FIG. 2 shows a schematic representation (not to scale) of the refractive index profile of an alternative exemplary embodiment of multimode optical fiber disclosed herein wherein a glass cladding surrounds the core and a polymeric coating surrounds the glass cladding.

FIG. 3 shows a schematic representation (not to scale) of the refractive index profile of an exemplary embodiment of multimode optical fiber disclosed herein wherein a depressed glass cladding region surrounds the core and a polymeric coating surrounds the glass cladding.

FIG. 4 shows a schematic representation (not to scale) of the refractive index profile of an exemplary embodiment of multimode optical fiber disclosed herein wherein a glass cladding surrounds the core, the glass cladding region comprising depressed glass cladding region, and a polymeric coating surrounds the glass cladding.

FIG. 5 shows a schematic representation (not to scale) of the refractive index profile of an exemplary embodiment of multimode optical fiber disclosed herein wherein the core is surrounded by a coating having a lower refractive index than that of the core, and a second polymeric coating surrounding the first coating.

### DETAILED DESCRIPTION

Additional features and advantages will be set forth in the detailed description which follows and will be apparent to those skilled in the art from the description or recognized by practicing the exemplary embodiments as described in the following description together with the claims and appended drawings.

The “refractive index profile” is the relationship between refractive index or relative refractive index and waveguide fiber radius.

The “relative refractive index percent” is defined as Δ%=100×(nᵢ²−n_{REF}²)/2nᵢ², where nᵢ is the maximum refractive index in region i, unless otherwise specified. The relative refractive index percent is measured at 850 nm unless otherwise specified. Unless otherwise specified herein, n_{REF} is the refractive index of pure undoped silica (1.452).

As used herein, the relative refractive index is represented by Δ and its values are given in units of “%”, unless otherwise specified. In cases where the refractive index of a region is less than the reference index n_{REF}, the relative index percent is negative and is referred to as having a depressed region or depressed-index, and the minimum relative refractive index is calculated at the point at which the relative index is most negative unless otherwise specified. In cases where the refractive index of a region is greater than the reference index n_{REF}, the relative index percent is positive and the region can be said to be raised or to have a positive index. An “updopant” is herein considered to be a dopant which has a propensity to raise the refractive index relative to pure undoped SiO₂.

Macrobend performance was determined according to FOTP-62 (IEC-60793-1-47) by wrapping 1 turn around a either a 5 mm, or 3 mm or similar diameter mandrel (e.g. “1×5 mm diameter macrobend loss” or the “1×3 mm diameter macrobend loss”) and measuring the increase in attenuation due to the bending using an overfilled launch condition where the optical source has a spot size that is greater than 50% of the core diameter of the fiber under test.

As used herein, numerical aperture of the fiber means numerical aperture as measured using the method set forth in TIA SP3-2839-URV2 FOTP-177 IEC-60793-1-43 titled “Measurement Methods and Test Procedures-Numerical Aperture”.

The term “α-profile” or “alpha profile” refers to a relative refractive index profile, expressed in terms of Δ(r) which is in units of “%”, where r is radius, which follows the equation,

Δ(r)=Δ(rₒ)(1−[|r−rₒ|/(r₁−rₒ)]^{α}),

where rₒ is zero unless otherwise specified, r₁ is the point at which Δ(r) % is zero, and r is in the range rᵢ≦r≦r_{f}, where Δ is defined above, rᵢ is the initial point of the α-profile, r_{f} is the final point of the α-profile, and α is an exponent which is a real number.

The depressed-index annular portion has a profile volume, V₃, defined herein as:

$${R}_{OUTER} 2 \int {Δ}_{3} ( r ) r dr {R}_{INNER}$$

where R_{INNER} is the depressed-index annular portion inner radius and R_{OUTER} is the depressed-index annular portion outer radius as defined.

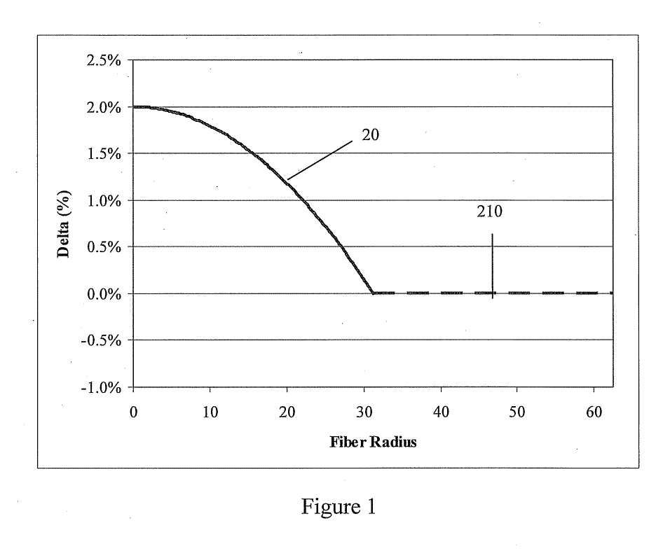

FIG. 1 illustrates a schematic representation of the refractive index profile of a cross-section of the glass portion of one exemplary embodiment of a multimode optical fiber comprising a multimode glass core 20 and a coating 210 directly adjacent to the core 20. The core 20 has outer radius R₁ and maximum refractive index delta Δ1_{MAX}. The coating 210 is preferably comprised of a primary and a secondary coating. In the embodiment illustrated in FIG. 1, the primary coating is applied onto core 20 and comprises a refractive index between about 1.435 to 1.460 over a temperature range of about 0-50° C. By this we mean that the coating exhibits a refractive index between 1.435 and 1.460 at every temperature between 0 and 50° C. In some preferred embodiments, the coating exhibits a refractive index between 1.440 and 1.455 at 25° C.

For example, the primary coating may be PC452 and the secondary coating may be CPC-6 secondary. PC452 is a fluorinated polymer having a refractive index of 1.452 at 25° C., and is available from SSCP CO., LTD 403-2, Moknae, Ansan, Kyunggi, Korea. However, other coatings having similar refractive index (e.g., 1.435 to 1.460 over a temperature range of about 0-50° C., and/or a refractive index between 1.440 and 1.455 at 25° C.).

CPC-6 secondary coating is a urethane acylate coating manufactured by DSM Desotech, Elgin, Ill. However, other high modulus secondary coatings could also be employed or the fiber may be directly buffered without a secondary coating layer. Common buffering materials may include Teflon®, Tefzel®, Hytrel®, nylon and other similar materials.

The primary coating may have a thickness between about 5 and 25 um, more preferably between about 7 and 20 um, even more preferably between about 10 and 15 um and the secondary may have a thickness between about 0 and 70 um, more preferably between 20 and 30 um so that the entire fiber diameter, including coating is between 125 um and 250 um, more preferably between about 130 and 200 um, even more preferably between about 150 and 180 um. The primary coating composition when cured preferably exhibits a 2.5% secant modulus of between 5 and 55 (kgf/mm̂2), more preferably between 10 and 40 (kgf/mm̂2), and even more preferably between 20 and 30 (kgf/mm̂2).

For example, the secondary coatings disclosed in U.S. Pat. No. 6,775,451, the specification of which is hereby incorporated by reference, could be utilized as secondary coatings. The secondary composition when cured preferably exhibits a Young's modulus of at least 650 MPa, more preferably at least 900 MPa, and even more preferably at least 1000 MPa.

The secondary coating may include, for example, an oligomeric component present in an amount of about 15 weight percent or less and a monomeric component present in an amount of about 75 weight percent or more, where the monomeric component includes two or more monomers when the composition is substantially devoid of the oligomeric component and the cured product of the composition has a Young's modulus of at least about 650 MPa. As used herein, the weight percent of a particular component refers to the amount introduced into the bulk composition, excluding other additives. The amount of other additives that are introduced into the bulk composition to produce a composition is listed in parts per hundred. For example, an oligomer, monomer, and photoinitiator are combined to form the bulk composition such that the total weight percent of these components equals 100 percent. To this bulk composition, an amount of an additive, for example 1.0 part per hundred of an antioxidant, is introduced in excess of the 100 weight percent of the bulk composition.

The monomeric component can include a single monomer or it can be a combination of two or more monomers. Although not required, it is preferable that the monomeric component be a combination of two or more monomers when the composition is substantially devoid of the oligomeric component. Preferably, the monomeric component introduced into the composition comprises ethylenically unsaturated monomer(s). While the monomeric component can be present in an amount of 75 weight percent or more, it is preferably present in an amount of about 75 to about 99.2 weight percent, more preferably about 80 to about 99 weight percent, and most preferably about 85 to about 98 weight percent.

Ethylenically unsaturated monomers may contain various functional groups which enable their cross-linking. The ethylenically unsaturated monomers are preferably polyfunctional (i.e., each containing two or more functional groups), although monofunctional monomers can also be introduced into the composition. Therefore, the ethylenically unsaturated monomer can be a polyfunctional monomer, a monofunctional monomer, and mixtures thereof. Suitable functional groups for ethylenically unsaturated monomers include, without limitation, acrylates, methacrylates, acrylamides, N-vinyl amides, styrenes, vinyl ethers, vinyl esters, acid esters, and combinations thereof (i.e., for polyfunctional monomers).

In general, individual monomers capable of about 80% or more conversion (i.e., when cured) are more desirable than those having lower conversion rates. The degree to which monomers having lower conversion rates can be introduced into the composition depends upon the particular requirements (i.e., strength) of the resulting cured product. Typically, higher conversion rates will yield stronger cured products.

Suitable polyfunctional ethylenically unsaturated monomers include, without limitation, alkoxylated bisphenol A diacrylates such as ethoxylated bisphenol A diacrylate with ethoxylation being 2 or greater, preferably ranging from 2 to about 30 (e.g. SR349 and SR601 available from Sartomer Company, Inc. West Chester, Pa. and Photomer 4025 and Photomer 4028, available from Henkel Corp. (Ambler, Pa.)), and propoxylated bisphenol A diacrylate with propoxylation being 2 or greater, preferably ranging from 2 to about 30; methylolpropane polyacrylates with and without alkoxylation such as ethoxylated trimethylolpropane triacrylate with ethoxylation being 3 or greater, preferably ranging from 3 to about 30 (e.g., Photomer 4149, Henkel Corp., and SR499, Sartomer Company, Inc.), propoxylated-trimethylolpropane triacrylate with propoxylation being 3 or greater, preferably ranging from 3 to 30 (e.g., Photomer 4072, Henkel Corp: and SR492, Sartomer), and ditrimethylolpropane tetraacrylate (e.g., Photomer 4355, Henkel Corp.); alkoxylated glyceryl triacrylates such as propoxylated glyceryl triacrylate with propoxylation being 3 or greater (e.g., Photomer 4096, Henkel Corp. and SR9020, Sartomer); erythritol polyacrylates with and without alkoxylation, such as pentaerythritol tetraacrylate (e.g., SR295, available from Sartomer Company, Inc. (West Chester, Pa.)), ethoxylated pentaerythritol tetraacrylate (e.g., SR494, Sartomer Company, Inc.), and dipentaerythritol pentaacrylate (e.g., Photomer 4399, Henkel Corp., and SR399, Sartomer Company, Inc.); isocyanurate polyacrylates formed by reacting an appropriate functional isocyanurate with an acrylic acid or acryloyl chloride, such as tris-(2-hydroxyethyl) isocyanurate triacrylate (e.g., SR368, Sartomer Company, Inc.) and tris-(2-hydroxyethyl) isocyanurate diacrylate; alcohol polyacrylates with and without alkoxylation such as tricyclodecane dimethanol diacrylate (e.g., CD406, Sartomer Company, Inc.) and ethoxylated polyethylene glycol diacrylate with ethoxylation being 2 or greater, preferably ranging from about 2 to 30; epoxy acrylates formed by adding acrylate to bisphenol A diglycidylether (4 up) and the like (e.g., Photomer 3016, Henkel Corp.); and single and multi-ring cyclic aromatic or non-aromatic polyacrylates such as dicyclopentadiene diacrylate and dicyclopentane diacrylate.

It may also be desirable to use certain amounts of monofunctional ethylenically unsaturated monomers, which can be introduced to influence the degree to which the cured product absorbs water, adheres to other coating materials, or behaves under stress. Exemplary monofunctional ethylenically unsaturated monomers include, without limitation, hydroxyalkyl acrylates such as 2-hydroxyethyl-acrylate, 2-hydroxypropyl-acrylate, and 2-hydroxybutyl-acrylate; long- and short-chain alkyl acrylates such as methyl acrylate, ethyl acrylate, propyl acrylate, isopropyl acrylate, butyl acrylate, amyl acrylate, isobutyl acrylate, t-butyl acrylate, pentyl acrylate, isoamyl acrylate, hexyl acrylate, heptyl acrylate, octyl acrylate, isooctyl acrylate, 2-ethylhexyl acrylate, nonyl acrylate, decyl acrylate, isodecyl acrylate, undecyl acrylate, dodecyl acrylate, lauryl acrylate, octadecyl acrylate, and stearyl acrylate; aminoalkyl acrylates such as dimethylaminoethyl acrylate, diethylaminoethyl acrylate, and 7-amino-3,7-dimethyloctyl acrylate; alkoxyalkyl acrylates such as butoxylethyl acrylate, phenoxyethyl acrylate (e.g., SR339, Sartomer Company, Inc.), and ethoxyethoxyethyl acrylate; single and multi-ring cyclic aromatic or non-aromatic acrylates such as cyclohexyl acrylate, benzyl acrylate, dicyclopentadiene acrylate, dicyclopentanyl acrylate, tricyclodecanyl acrylate, bornyl acrylate, isobornyl acrylate (e.g., SR423, Sartomer Company, Inc.), tetrahydrofurfuryl acrylate (e.g., SR285, Sartomer Company, Inc.), caprolactone acrylate (e.g., SR495, Sartomer Company, Inc.), and acryloylmorpholine; alcohol-based acrylates such as polyethylene glycol monoacrylate, polypropylene glycol monoacrylate, methoxyethylene glycol acrylate, methoxypolypropylene glycol acrylate, methoxypolyethylene glycol acrylate, ethoxydiethylene glycol acrylate, and various alkoxylated alkylphenol acrylates such as ethoxylated (4) nonylphenol acrylate (e.g., Photomer 4003, Henkel Corp.); acrylamides such as diacetone acrylamide, isobutoxymethyl acrylamide, N,N′-dimethyl-aminopropyl acrylamide, N,N-dimethyl acrylamide, N,N diethyl acrylamide, and t-octyl acrylamide; vinylic compounds such as N-vinylpyrrolidone and N-vinylcaprolactarn; and acid esters such as maleic acid ester and fumaric acid ester. With respect to the long and short chain alkyl acrylates listed above, a short chain alkyl acrylate is an alkyl group with 6 or less carbons and a long chain alkyl acrylate is alkyl group with 7 or more carbons.

Most suitable monomers are either commercially available or readily synthesized using reaction schemes known in the art. For example, most of the above-listed monofunctional monomers can be synthesized by reacting an appropriate alcohol or amide with an acrylic acid or acryloyl chloride.

The oligomeric component can include a single type of oligomer or it can be a combination of two or more oligomers. When employed, if at all, the oligomeric component preferably comprises ethylenically unsaturated oligomers. While the oligomeric component can be present in an amount of 15 weight percent or less, it is preferably present in an amount of about 13 weight percent or less, more preferably about 10 weight percent or less. While maintaining suitable physical characteristics of the composition and its resulting cured material, it is more cost-effective and, therefore, desirable to prepare compositions containing preferably less than about 5 weight percent or substantially devoid of the oligomeric component.

When employed, suitable oligomers can be either monofunctional oligomers or polyfunctional oligomers, although polyfunctional oligomers are preferred. The oligomeric component can also be a combination of a monofunctional oligomer and a polyfunctional oligomer.

Di-functional oligomers preferably have a structure according to formula (I) below:

F₁—R₁-[Diisocyanate-R₂-Diisocyanate]ₘ—R₁—F₁ (I)

where F₁ is independently a reactive functional group such as acrylate, methacrylate, acrylamide, N-vinyl amide, styrene, vinyl ether, vinyl ester, or other functional group known in the art; R₁ includes, independently, —C₂₋₁₂O—, —(C₂₋₄—O)ₙ—,—C₂₋₁₂O—(C₂₋₄—O)ₙ—,—C₂₋₁₂O—(CO—C₂₋₅O)ₙ—, or —C₂₋₁₂O—(CO—C₂₋₅NH)ₙ—where n is a whole number from 1 to 30, preferably 1 to 10; R₂ is polyether, polyester, polycarbonate, polyamide, polyurethane, polyurea, or combinations thereof; and m is a whole number from 1 to 10, preferably 1 to 5. In the structure of formula I, the diisocyanate group is the reaction product formed following bonding of a diisocyanate to R₂ and/or R₁. The term “independently” is used herein to indicate that each F₁ may differ from another F₁ and the same is true for each R₁.

Other polyfunctional oligomers preferably have a structure according to formula (II), formula (III), or formula (IV) as set forth below:

multiisocyanate-(₂—R₁—F₂)ₓ (II)

polyol-[(diisocyanate-R₂-diisocyanate)ₘ-R₁—F₂]ₓ (III)

or

multiisocyanate-(R₁—F₂)ₓ (IV)

where F₂ independently represents from 1 to 3 functional groups such as acrylate, methacrylate, acrylamide, N-vinyl amide, styrene, vinyl ether, vinyl ester, or other functional groups known in the art; R₁ can include—C₂₋₁₂O—,—(C₂₋₄—O)ₙ—, —C₂₋₁₂O—(C₂₋₄—O)ₙ—,—C₂₋₁₂O—(CO—C₂₋₅O)ₙ—, or —C₂₋₁₂O—(CO—C₂₋₅NH)ₙ—where n is a whole number from 1 to 10, preferably 1 to 5; R₂ can be polyether, polyester, polycarbonate, polyamide, polyurethane, polyurea or combinations thereof; x is a whole number from 1 to 10, preferably 2 to 5; and m is a whole number from 1 to 10, preferably 1 to 5. In the structure of formula II, the multiisocyanate group is the reaction product formed following bonding of a multiisocyanate to R₂. Similarly, the diisocyanate group in the structure of formula III is the reaction product formed following bonding of a diisocyanate to R₂ and/or R₁.

Urethane oligomers are conventionally provided by reacting an aliphatic diisocyanate with a dihydric polyether or polyester, most typically a polyoxyalkylene glycol such as a polyethylene glycol. Such oligomers typically have between about four to about ten urethane groups and may be of high molecular weight, e.g., 2000-8000. However, lower molecular weight oligomers, having molecular weights in the 500-2000 range, may also be used. U.S. Pat. No. 4,608,409 to Coady et al. and U.S. Pat. No. 4,609,718 to Bishop et al., which are hereby incorporated by reference, describe such syntheses in detail.

When it is desirable to employ moisture-resistant oligomers, they may be synthesized in an analogous manner, except that the polar polyether or polyester glycols are avoided in favor of predominantly saturated and predominantly nonpolar aliphatic diols. These diols include, for example, alkane or alkylene diols of from about 2-250 carbon atoms and, preferably, are substantially free of ether or ester groups.

As is well known, polyurea components may be incorporated in oligomers prepared by these methods, simply by substituting diamines or polyamines for diols or polyols in the course of synthesis. The presence of minor proportions of polyurea components in the present coating systems is not considered detrimental to coating performance, provided only that the diamines or polyamines employed in the synthesis are sufficiently non-polar and saturated as to avoid compromising the moisture resistance of the system.

As is well known, optical fiber coating compositions may also contain a polymerization initiator which is suitable to cause polymerization (i.e., curing) of the composition after its application to a glass fiber or previously coated glass fiber. Polymerization initiators suitable for use in the compositions include thermal initiators, chemical initiators, electron beam initiators, microwave initiators, actinic-radiation initiators, and photoinitiators. Particularly preferred are the photoinitiators. For most acrylate-based coating formulations, conventional photoinitiators, such as the known ketonic photoinitiating and/or phosphine oxide additives, are preferred. When used, the photoinitiator may be present in an amount sufficient to provide rapid ultraviolet curing. Generally, this includes about 0.5 to about 10.0 weight percent, more preferably about 1.5 to about 7.5 weight percent.

The photoinitiator, when used in a small but effective amount to promote radiation cure, must provide reasonable cure speed without causing premature gelation of the coating composition. A desirable cure speed is any speed sufficient to cause substantial curing (i.e., greater than about 90%, more preferably 95%) of the coating composition. As measured in a dose versus modulus curve, a cure speed for coating thicknesses of about 25-35 μm is, e.g., less than 1.0 J/cm², preferably less than 0.5 J/cm².

Suitable photoinitiators include, without limitation, 1-hydroxycyclohexylphenyl ketone (e.g.; Irgacure 184 available from Ciba Specialty Chemical (Tarrytown, N.Y.)), (2,6-diethoxybenzoyl)-2,4,4-trimethylpentyl phosphine oxide (e.g. in commercial blends Irgacure 1800, 1850, and 1700, Ciba Specialty Chemical), 2,2-dimethoxyl-2-phenyl acetophenone (e.g., Irgacure, 651, Ciba Specialty Chemical), bis(2,4,6-trimethylbenzoyl) phenyl phosphine oxide (e.g., Irgacure 819, Ciba Specialty Chemical), (2,4,6-triiethylbenzoyl)diphenyl phosphine oxide (e.g., in commercial blend Darocur 4265, Ciba Specialty Chemical), 2-hydroxy-2-methyl-1-phenylpropane-1-one (e.g., in commercial blend Darocur 4265, Ciba Specialty Chemical) and combinations thereof. Other photoinitiators are continually being developed and used in coating compositions on glass fibers. Any suitable photoinitiator can be introduced into compositions disclosed herein.

In addition to the above-described components, the secondary coating composition can optionally include an additive or a combination of additives. Suitable additives include, without limitation, antioxidants, catalysts, lubricants, low molecular weight non-crosslinking resins, adhesion promoters, and stabilizers. Some additives can operate to control the polymerization process, thereby affecting the physical properties (e.g., modulus, glass transition temperature) of the polymerization product formed the composition. Others can affect the integrity of the polymerization product of the composition (e.g., protect against de-polymerization or oxidative degradation).

A preferred antioxidant is thiodiethylene bis(3,5-di-tert-butyl)-4-hydroxyhydrocinnamate (e.g., Irganox 1035, available from Ciba Specialty Chemical).

A preferred adhesion promoter is an acrylated acid adhesion promoter such as Ebecryl 170 (available from UCB Radcure (Smyrna Ga.)).

Other suitable materials for use in secondary coating materials, as well as considerations related to selection of these materials, are well known in the art and are described in U.S. Pat. Nos. 4,962,992 and 5,104,433 to Chapin, which are hereby incorporated by reference. Various additives that enhance one or more properties of the coating can also be present, including the above-mentioned additives.

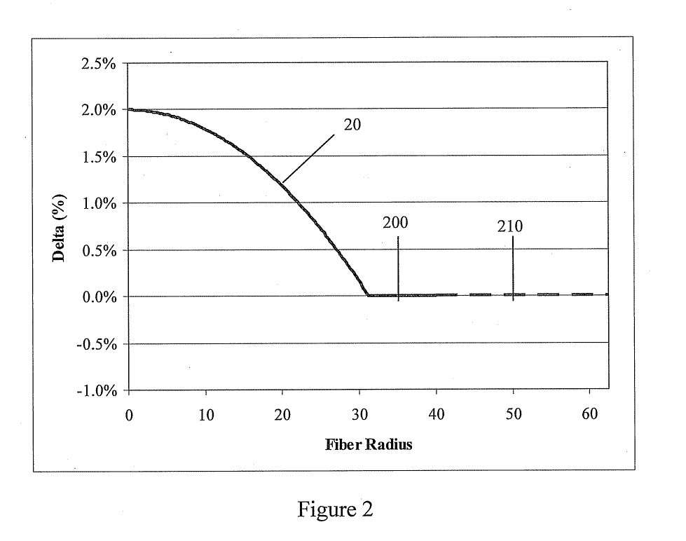

FIG. 2 illustrates a schematic representation of the refractive index profile of a cross-section of the glass portion of one exemplary embodiment of a multimode optical fiber comprising a multimode glass core 20, a glass cladding 200 surrounding the core 20 and a coating 210 surrounding the glass cladding 200. The cladding 200 may be, for example, undoped silica glass. The core 20 has outer radius R₁ and maximum refractive index delta Δ1_{MAX}. In the embodiment illustrated in FIG. 2, the cladding 200 preferably exhibits a width less than Sum.

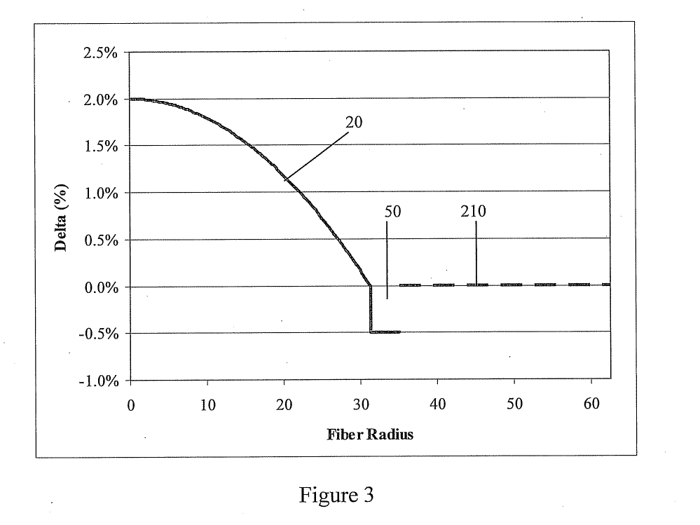

FIG. 3 illustrates a schematic representation of the refractive index profile of an alternative exemplary embodiment of a multimode optical fiber comprising a multimode glass core 20, a glass cladding 200 surrounding the core 20 and a coating 210 surrounding the glass cladding 200. The cladding 200 comprises depressed-index annular portion 50. Depressed-index annular portion 50 has minimum refractive index delta percent Δ2_{MIN}, width W₂ and outer radius R₂. The depressed-index annular portion 50 is shown directly adjacent to the core 20. Preferably, Δ1_{MAX}>Δ2_{MIN}. The depressed index portion 50 preferably exhibits a refractive index delta less than about −0.2% and a width of at least 5 micron, more preferably a refractive index delta less than about −0.4% and a width of at least 3 microns.

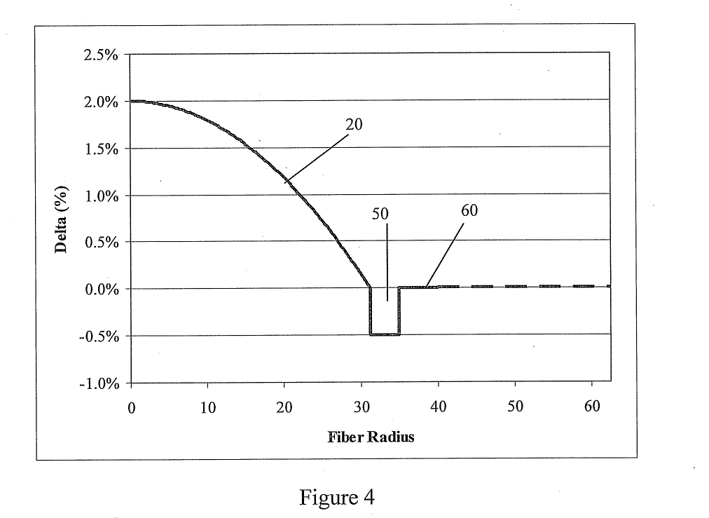

FIG. 4 illustrates a schematic representation of the refractive index profile of a cross-section of the glass portion of one exemplary embodiment of a multimode optical fiber comprising a multimode glass core 20, a glass cladding 200 surrounding the core 20 and a coating 210 surrounding the glass cladding 200. The cladding 200 comprises depressed-index annular portion 50. Depressed-index annular portion 50 has minimum refractive index delta percent Δ2_{MIN}, width W₂ and outer radius R₂. In the embodiment illustrated, the depressed-index annular portion 50 is shown directly adjacent to the core 20. The outer annular cladding portion 60 has a refractive index profile Δ3(r). Preferably, Δ1>Δ3>Δ2_{MIN}. In some embodiments, the outer annular portion 60 has a substantially constant refractive index profile, as shown in FIG. 4 with a constant Δ3(r); in some of these embodiments, Δ3(r)=0%.

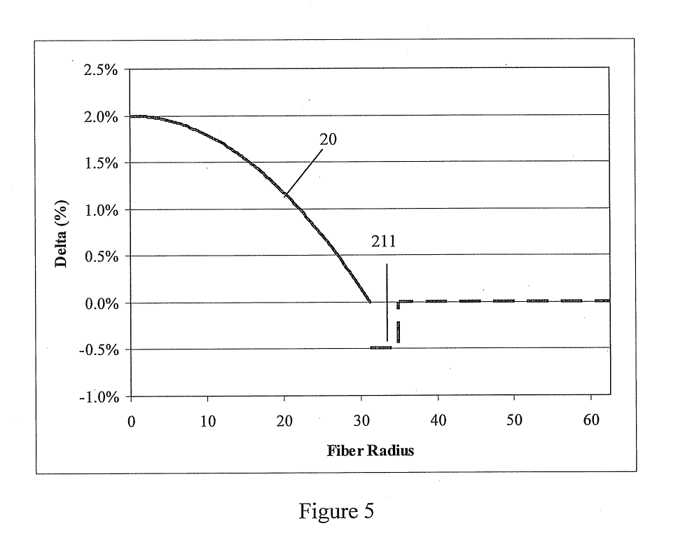

FIG. 5 illustrates a schematic representation of the refractive index profile of an alternative exemplary embodiment comprising a multimode glass core 20 and a coating 210 surrounding the glass cladding 200. The coating 210 comprises a primary coating 211 which is a depressed-index coating, for example, a coating having a refractive index of about 1.446. Primary coating 210 has width W₂ and outer radius R₂. The primary coating 210 in the embodiment illustrated in FIG. 5 is shown directly adjacent to the core 20.

In all of the above embodiments, the multimode core 20 preferably has an entirely positive refractive index profile, where Δ1(r)>0%. R₁ is defined as the radius at which the refractive index delta of the core first reaches a value of 0, going radially outwardly from the centerline. R₁ preferably is greater than 30 microns, more preferably R₁ is greater than or equal to 35 microns, and most preferably R₁ is greater than or equal to 40 microns.

Preferably, the core contains substantially no fluorine, and more preferably the core contains no fluorine. The core 20 has outer radius R₁ and maximum refractive index delta Δ1_{MAX}. Preferably Δ1_{MAX} is greater or equal to 2.5% and greater than 0.5%, more preferably less than 2.2% and greater than 0.9%.

In the multimode optical fiber disclosed herein, the core is a graded-index core, and preferably, the refractive index profile of the core has a parabolic (or substantially parabolic) shape; for example, in some embodiments, the refractive index profile of the core has an α-shape with an α value preferably between 1.9 and 2.3, more preferably about 2.1, as measured at 850 nm; in some embodiments, the refractive index of the core may have a centerline dip, wherein the maximum refractive index of the core, and the maximum refractive index of the entire optical fiber, is located a small distance away from the centerline, but in other embodiments the refractive index of the core has no centerline dip, and the maximum refractive index of the core, and the maximum refractive index of the entire optical fiber, is located at the centerline. The parabolic shape extends to a radius R₁ and preferably extends from the centerline of the fiber to R₁. Referring to the Figures, the core 20 is defined to end at the radius R₁ where the parabolic shape ends, coinciding with the innermost radius of the cladding 200.

Primary coating 210 contacts the outermost portion of the glass portion of the optical fiber. In all of the above described embodiments, primary coating 210 is preferably comprised of at least a primary coating which is applied directly onto the outermost glass surface of the optical fiber. The primary coating preferably comprises a refractive index between about 1.435 to 1.460 over the temperature range of about 0-50° C. In some preferred embodiments, the refractive index of the primary coating is between 1.440 and 1.455 at 25° C. Suitable coating materials may include fluorinated polymers and other materials having indices of refraction within these preferred ranges.

For example, the primary coating may be EFIRON® PC-452 or EFIRON®PC-444 radiation-curable acrylates, both of which are fluorinated polymers available from commercially available from SSCP CO., LTD 403-2, Moknae, Ansan, Kyunggi, Korea Tel+82-31-490-3600 EFIRON® PC-452 has an index of refraction of 1.452 and EFIRON®PC-444 has an index of refraction of 1.444 at 25° C. However, other coatings can also be employed, for example other materials that have a refractive index between 1.435 to 1.460 over the temperature range of about 0-50° C. The primary coating may have a thickness between about 5 and 25 um and the secondary may have a thickness between about 5 and 70 um, so that the entire fiber diameter, including coating is between 125 um and 250 um.

A secondary coating may also be applied onto the primary coating to thereby form a dual coating 210. Secondary coating may be a protective coating having higher Young's modulus than the primary coating.

One or more portions of the clad layer 200 may be comprised of a cladding material which was deposited, for example during a laydown process, or which was provided in the form of a jacketing, such as a tube in a rod-in-tube optical preform arrangement, or a combination of deposited material and a jacket. The clad layer 200 is surrounded by at least one coating 210, which may in some embodiments comprise a low modulus primary coating and a high modulus secondary coating.

Preferably, the optical fiber disclosed herein has a silica-based core and cladding. In some embodiments, the cladding has an outer diameter, 2 times Rmax, 130 microns or less, e.g. of about 125 μm. In some embodiments, one or more coatings surround and are in contact with the cladding. The coating can be a polymer coating such as an acrylate-based polymer.

In some embodiments, the fiber employs a depressed-index annular portion which comprises voids, either non-periodically disposed, or periodically disposed, or both. By “non-periodically disposed” or “non-periodic distribution”, we mean that when one takes a cross section (such as a cross section perpendicular to the longitudinal axis) of the optical fiber, the non-periodically disposed voids are randomly or non-periodically distributed across a portion of the fiber. Similar cross sections taken at different points along the length of the fiber will reveal different cross-sectional hole patterns, i.e., various cross sections will have different hole patterns, wherein the distributions of voids and sizes of voids do not match. That is, the voids or voids are non-periodic, i.e., they are not periodically disposed within the fiber structure. These voids are stretched (elongated) along the length (i.e. parallel to the longitudinal axis) of the optical fiber, but do not extend the entire length of the entire fiber for typical lengths of transmission fiber. It is believed that the voids extend less than a few meters, and in many cases less than 1 meter along the length of the fiber. Optical fiber disclosed herein can be made by methods which utilize preform consolidation conditions which are effective to result in a significant amount of gases being trapped in the consolidated glass blank, thereby causing the formation of voids in the consolidated glass optical fiber preform. Rather than taking steps to remove these voids, the resultant preform is used to form an optical fiber with voids, or voids, therein. As used herein, the diameter of a hole is the longest line segment whose endpoints are disposed on the silica internal surface defining the hole when the optical fiber is viewed in perpendicular cross-section transverse to the longitudinal axis of the fiber.

In some embodiments, the inner annular portion 30 comprises silica which is substantially undoped with either fluorine or germania. The annular portion 30 may preferably comprise a width of less than 4.0 microns, more preferably less than 2.0 microns. In some embodiments, the outer annular portion 60 comprises substantially undoped silica, although the silica may contain some amount of chlorine, fluorine, germania, or other dopants in concentrations that collectively do not significantly modify the refractive index. In some embodiments, the depressed-index annular portion 50 comprises silica doped with fluorine and/or boron. In some other embodiments, the depressed-index annular portion 50 comprises silica comprising a plurality of non-periodically disposed voids. The voids can contain one or more gases, such as argon, nitrogen, krypton, CO₂, SO₂, or oxygen, or the voids can contain a vacuum with substantially no gas; regardless of the presence or absence of any gas, the refractive index in the annular portion 50 is lowered due to the presence of the voids. The voids can be randomly or non-periodically disposed in the annular portion 50 of the cladding 200, and in other embodiments, the voids are disposed periodically in the annular portion 50. Alternatively, or in addition, the depressed index in annular portion 50 can also be provided by downdoping the annular portion 50 (such as with fluorine) or updoping one or more portions of the cladding and/or the core, wherein the depressed-index annular portion 50 is, for example, silica which is not doped as heavily as the inner annular portion 30. Preferably, the minimum relative refractive index, or average effective relative refractive index, such as taking into account the presence of any voids, of the depressed-index annular portion 50 is preferably less than −0.1%, more preferably less than about −0.2 percent, even more preferably less than about −0.3 percent, and most preferably less than about −0.4 percent.

The numerical aperture (NA) of the optical fiber is preferably greater than the NA of the optical source directing signals into the fiber; for example, the NA of the optical fiber is preferably greater than the NA of a VCSEL source.

Set forth in the table below are a variety of examples. Each of examples 1-5 have refractive index profiles similar to that described above with respect to FIG. 1. In particular, the peak delta of the core is set forth, along with the core radius R1, the particular primary) (1° coating and its diameter, the particular secondary (2° coating and its outer diameter, the peak refractive index of the core and the primary coating and predicted fiber numerical aperture (NA). Also set forth in Table 1 are various actual measured macrobend and actual measured bandwidth data.

| | | | | 1° | | 2° | Core Glass | 1° Coating | |
|---|---|---|---|---|---|---|---|---|---|
| | | | 1° | coating | 2° | Coating | Index @ | Index @ | Predicted |
| Ex. | Δ1 | R1 | Coating | OD (um) | Coating | OD (um) | 852 nm * | 852 nm | Fiber NA |
| 1 | 2% | 100 | PC452 | 117 | CPC6 | 124 | 1.478 | 1.452 | 0.277 |
| 2 | 2% | 100 | PC452 | 117 | CPC6 | 124 | 1.478 | 1.452 | 0.277 |
| 3 | 2% | 80 | PC452 | 111 | CPC6 | 122 | 1.478 | 1.452 | 0.277 |
| 4 | 2% | 80 | PC452 | 111 | CPC6 | 122 | 1.478 | 1.452 | 0.277 |
| 5 | 1% | 100 | PC444 | 117 | CPC6 | 124 | 1.465 | 1.444 | 0.247 |

* For graded profiles index is value at peak delta

macrobend attenuation (dB)

| | no offset | no offset | offset | offset | offset | | | |
|---|---|---|---|---|---|---|---|---|
| | 1x 180° | 2x 90° | 2x 90° | 1x 180° | 2x 90° | 2x 90° | OFL | OFL |
| no offset | turn @ | turns 2 | turns 3 | turn @ | turns 2 | turns 3 | BW | BW |
| Ex. | 1.5 mm R | mm R | mm R | 1.5 mm R | mm R | mm R | 850 nm | 1300 nm |
| 1 | 0.15 | 0.03 | 0.01 | 0.589 | 0.233 | 0.055 | | |
| 2 | 0.26 | 0.01 | 0.01 | 0.576 | 0.012 | 0.034 | | |
| 3 | 0.62 | 0.08 | −0.03 | 1.004 | 0.235 | 0.043 | 588 | 616 |
| 4 | 0.16 | 0.03 | 0.02 | 0.49 | 0.073 | 0.041 | 548 | 1264 |
| 5 | 1.29 | 0.06 | 0.05 | 0.555 | 0.49 | 0.028 | | |

It is to be understood that the foregoing description of the preferred embodiments is exemplary only and is intended to provide an overview for the understanding of the nature and character of the invention as it is defined by the claims. The accompanying drawings are included to provide a further understanding and are incorporated and constitute part of this specification. The drawings illustrate various features and preferred embodiments which, together with their description, serve to explain the principals and operation of the invention. It will become apparent to those skilled in the art that various modifications to the preferred embodiments of the invention as described herein can be made without departing from the spirit or scope of the invention as defined by the appended claims.

What is claimed is:

1. A multimode optical fiber comprising:
a graded index glass core comprising a core radius greater than 25 microns and a polymer coating applied to the outside of said fiber, said coating spaced from said core no more than 15 microns from said core, wherein said coating comprises a refractive index between about 1.460 to 1.435 over the temperature range of from about 0 to about 50° C.

2. The multimode fiber of claim 1, wherein the core of said fiber exhibits a peak refractive index delta between about 0.8 and 3%.

3. The multimode fiber of claim 1, wherein said fiber exhibits an overfilled bandwidth at 850 nm greater than 400 MHz-km.

4. The multimode fiber of claim 1, wherein said fiber exhibits a core diameter greater than 60 microns.

5. The multimode fiber of claim 4, wherein said fiber exhibits a core diameter less than 140 microns.

6. The multimode fiber of claim 1, wherein said coating is a fluorinated polymer.

7. The multimode fiber of claim 1, wherein said coating is directly adjacent to said core.

8. The multimode fiber of claim 1, wherein said fiber further comprises a silica based glass cladding region between said core and said coating.

9. The multimode fiber of claim 8, wherein said silica based cladding is essentially free of index increasing or index decreasing dopants.

10. The multimode fiber of claim 8, wherein said silica based cladding region further comprises a depressed index annular region surrounding said core, said depressed index annular region comprising fluorine, boron or a combination of both dopants such that the region exhibits a refractive index delta less than about −0.2%.

11. The multimode fiber of claim 1, wherein said fiber exhibits an overfilled bandwidth at 850 nm which is greater than 500 MHz-km.

12. The fiber of claim 1, wherein said fiber further exhibits a 1 turn 5 mm diameter mandrel wrap attenuation increase, of less than or equal to 0.5 dB/turn at 850 nm.

13. The fiber of claim 1, wherein said fiber further exhibits a 1 by 180 degree turn around a 3 mm diameter mandrel wrap attenuation increase, of less than or equal to 0.5 dB/turn at 850 nm.

14. The fiber of claim 10, wherein said depressed-index annular portion has a width less than 10 microns.

15. The multimode fiber of claim 1, wherein said fiber exhibits an overfilled bandwidth at 850 nm which is greater than 1500 MHz-km.

16. The multimode fiber of claim 1, wherein said fiber exhibits a numerical aperture greater than 0.22 and less than 0.36.

17. The multimode fiber of claim 1, wherein said fiber exhibits a numerical aperture greater than 0.24 and less than 0.29.

18. The fiber of claim 1 wherein the maximum refractive index delta of the graded index glass core is greater than 0.8% and less than 2.2%.

19. A multimode optical fiber comprising:
a graded index glass core having a radius greater than 30 microns; and
an first inner cladding comprising a depressed-index annular portion, said depressed-index annular portion having a refractive index delta less than about −0.2% and a width of at least 1 micron, and said fiber further exhibits a 1 turn 15 mm diameter mandrel wrap attenuation increase, of less than or equal to 0.25 dB/turn at 850 nm, and an overfilled bandwidth greater than 500 MHz-km at 850 nm.

20. The multimode fiber of claim 19 further comprising a numerical aperture of greater than 0.185.

21. The multimode fiber of claim 19, wherein said depressed-index annular portion comprises fluorine.

22. The multimode fiber of claim 19, wherein said fiber further exhibits an overfilled bandwidth greater than 700 MHz-km at 850 nm.
